(19) United States
(12) Patent Application Publication
(10) Pub. No.: US 2004/0200267 A1
(43) Pub. Date: Oct. 14, 2004

(54) Apparatus and method for measuring specific gravity (concentration) of medium using ultrasonic wave

(75) Inventor: Bonkwang Koo, Anyang-shi (KR)

Correspondence Address: SYNNESTVEDT & LECHNER, LLP, 2600 ARAMARK TOWER, 1101 MARKET STREET, PHILADELPHIA, PA, 191072950

(73) Assignees: Shinwoo P&T Co., Ltd., Seoul (KR); Hansung Electronic Industries Development Co., Ltd., Seoul (KR)

(21) Appl. No.: 10/457,152

(22) Filed: Jun. 9, 2003

(30) Foreign Application Priority Data
Apr. 9, 2003 (KR) 2003-22447

(51) Int. Cl. G01N 9/24

(52) U.S. Cl. 73/32 A

(57) ABSTRACT

An apparatus and method for measuring a specific gravity (concentration) of a medium using an ultrasonic wave, which can measure a propagation velocity of the ultrasonic wave to recognize a change of density and temperature of the medium using the measured propagation velocity of the ultrasonic wave, and for measuring the specific gravity (concentration) of the medium using the recognized change of the density and temperature of the medium. In the apparatus, a controller performs a control operation for displaying at least one medium to be measured on a display unit such that a user can select the medium to be measured, measures a propagation velocity of the ultrasonic wave for the medium selected by the user, reads a conversion equation for a specific gravity (concentration) corresponding to the selected medium, and inputs a value of the measured propagation velocity of the ultrasonic wave into the conversion equation. The display unit displays the specific gravity (concentration) calculated automatically by the conversion equation for the specific gravity (concentration).

### BACKGROUND OF THE INVENTION

1. Field of the Invention

The present invention relates to an apparatus and method for measuring a specific gravity (concentration) of a medium using an ultrasonic wave, and more particularly to an apparatus and method for measuring a specific gravity (concentration) of a medium using an ultrasonic wave, which can measure a propagation velocity of the ultrasonic wave to recognize a change of density and temperature of the medium using the measured propagation velocity of the ultrasonic wave, and for measuring the specific gravity (concentration) of the medium using the recognized change of the density and temperature of the medium.

2. Description of the Related Art

Conventionally, vehicles such as gasoline and diesel vehicles are equipped with a vehicle battery 10 for using in an engine starting and ignition, illuminations and other electric devices. FIG. 1 is a view illustrating the vehicle battery 10; and FIG. 2 is a view illustrating a structure of an industrial battery 10-1.

As shown in FIG. 1, the vehicle battery 10 has a positive electrode 11 and a negative electrode 12 consisting of different metals arranged on an upper portion of the vehicle battery 10. The vehicle battery 10 contains an electrolyte.

If the positive electrode 11 is connected to a conductor, chemical energy from an active material of each electrode and the electrolyte can be converted into electric energy. The active material mainly uses lead, and the electrolyte uses colorless, odorless and dilute sulfuric acid having a high degree of purity. The fact that the sulfuric acid containing the lead is preferable was found by technical researches. Thus, the active material of the vehicle battery 10 mainly uses the lead.

In a state where the battery 10 has been fully charged, the electrolyte's specific gravity (concentration) at an electrolyte temperature 20° C. can be 1.240, 1.260 and 1.280 according to regions. In other words, the electrolyte's specific gravity at the electrolyte temperature 20° C. is 1.240 in a tropical region, 1.260 in a worm region, and 1.280 in a cold region. In Korea, the electrolyte's specific gravity at the electrolyte temperature 20° C. is 1.260.

In a state where the electrolyte's specific gravity (concentration) is 1.260 and the vehicle battery 10 is fully charged, a voltage of the vehicle battery 10 is 13.5V. If a predetermined period of time is elapsed, the vehicle battery 10 is discharged. Thus, the electrolyte's specific gravity (concentration) is decreased and hence the voltage is decreased. An amount of discharge of the vehicle battery 10 is increased as the temperature goes up.

Therefore, if the vehicle battery 10 has been fully discharged, it must be appropriately charged. A hydrometer 14 is arranged on the upper portion of the vehicle battery 10. The hydrometer 14 indicates a state of charge of the vehicle battery 10 in the form of an intensity of light.

If the electrolyte's specific gravity (concentration) becomes 1.060 or less and hence the battery's voltage becomes 9V or less, although the vehicle battery 10 is charged, it is difficult for the battery to be reused. The hydrometer 14 can indicate a state of charge of the vehicle battery 10 through an intensity of light. However, the user cannot correctly confirm the light intensity in the daytime. Thus, there is a problem in that the user cannot identify a point of time for charging the vehicle battery.

So there is seriously needed a measurer capable of easily and correctly measuring the electrolyte's specific gravity (concentration) of the vehicle battery so that the above problem can be addressed.

### SUMMARY OF THE INVENTION

Therefore, the present invention has been made in view of the above need and problem, and it is an object of the present invention to provide an apparatus, and method for measuring a specific gravity (concentration) of a medium using an ultrasonic wave, which can measure a propagation velocity of the ultrasonic wave to recognize a change of density and temperature of the medium using the measured propagation velocity of the ultrasonic wave, and for measuring the specific gravity (concentration) of the medium using the recognized change of the density and temperature of the medium using a device for converting an electric signal into an ultrasonic wave, a device for converting the ultrasonic wave into the electric signal and a device for generating and detecting the ultrasonic wave.

In accordance with one aspect of the present invention, the above and other objects can be accomplished by the provision of an apparatus for measuring a specific gravity (concentration) of a medium using an ultrasonic wave, comprising: control means for performing a control operation for displaying at least one medium to be measured on display means such that a user can select the medium to be measured, measuring a propagation velocity of the ultrasonic wave for the medium selected by the user, reading a conversion equation for a specific gravity (concentration) corresponding to the selected medium, and inputting a value of the measured propagation velocity of the ultrasonic wave into the conversion equation; and the display means for displaying the specific gravity (concentration) calculated automatically by the conversion equation for the specific gravity (concentration).

In accordance with another aspect of the present invention, there is provided an apparatus for measuring a specific gravity (concentration) of a medium using an ultrasonic wave, comprising: a manipulation unit including:

a power button for applying or cutting off a power supply voltage in response to a user's manipulation; and

a voltage measurement button for inputting a voltage measurement request;

a transmission/reception unit for receiving an electric signal to convert the electric signal into the ultrasonic wave, and receiving the ultrasonic wave to convert an ultrasonic wave into an electric signal;

a reference pulse generator for generating a reference pulse, to be used as a reference time, matching a measurement time;

a pulse divider for receiving the reference pulse from the reference pulse generator and generating a control clock and an ultrasonic wave transmission pulse;

a transmission driver including:

a transmission pulse counter for generating the predetermined number of pulses from the ultrasonic wave transmission pulse outputted by the pulse divider in response to a transmission start signal of an external input, and outputting the generated pulses; and

a transmission pulse controller for transmitting the pulses generated by the transmission pulse counter to the transmission/reception unit, and cutting off a transmission operation for the predetermined number of pulses in response to a control signal inputted by a controller; a receiving driver including:

a reception amplification and waveform shaping unit for amplifying the pulses, received from the transmission/reception unit, by a predetermined level, and shaping a waveform of the pulses;

a receiving pulse counter for counting reference pulses inputted by the reference pulse generator in response to a counting start signal inputted by the transmission pulse controller and stopping a counting operation for the reference pulses in response to a counting stop signal as an external input; and

a receiving pulse controller for counting the pulses received from the reception amplification and waveform shaping unit in response to the counting start signal inputted by the transmission pulse controller, comparing a comparative value corresponding to a count signal from the reception pulse counter outputting a reception completion signal with a reference value corresponding to the predetermined number of pulses, if the counted number of pulses matches the predetermined number of pulses, and outputting the counting stop signal to the receiving pulse counter if the comparative value matches the reference value;

a temperature measurer for measuring a temperature of a liquid;

a display unit for displaying measurement information in response to a control signal as an external input;

the controller for outputting the transmission start signal to the transmission pulse counter, after performing an auto setting operation in response to the control clock inputted by the pulse divider, if the power button of the manipulation unit is manipulated by the user so that the power supply voltage can be applied, keeping a standby state until the reception completion signal is inputted, counting a period of time between a pulse reception time and a pulse transmission time if the reception completion signal is inputted, measuring the specific gravity (concentration) of the medium, performing a control operation for displaying the measured specific gravity (concentration) and a temperature measured by a temperature measurer, outputting a voltage measurement control signal if the voltage measurement request button of the manipulation unit is manipulated by the user so that a voltage measurement request signal can be inputted, and performing a control operation for displaying a measured voltage on the display unit;

a voltage measurer for measuring a terminal voltage of a battery in response to a voltage measurement control signal from the controller; and

a transmitter for externally outputting data of the measured specific gravity (concentration), temperature and voltage according to a control operation of the controller.

Preferably, the reception amplification and waveform shaping unit may comprise: a non-inverting amplifier for removing a direct current (DC) component from an ultrasonic wave signal and amplifying the ultrasonic wave signal; a logarithmic amplifier for constantly keeping an amplitude of the amplified ultrasonic wave signal; a half wave rectifier circuit for outputting only an ultrasonic wave signal of a predetermined level or more in response to an offset value; a differential circuit for forming rising and falling edges of a half wave generated by the half wave rectifier circuit; a comparator being a zero volt detector for extracting a reference point of the ultrasonic wave signal and generating the ultrasonic wave signal of a square wave from the ultrasonic wave signal of a sinusoidal wave; an integration circuit for removing a spurious short signal from the ultrasonic wave signal; a Schmitt trigger circuit for shaping the ultrasonic wave signal of the square wave, removing a noise signal from the ultrasonic wave signal of the square wave, and outputting the ultrasonic wave signal; and a slope regulator for varying an amplification of the ultrasonic wave signal by regulating a slope of an output signal from the logarithmic amplifier.

Preferably, the controller may perform a control operation so that the power supply voltage applied to the transmission/reception unit can be cut off when the temperature measurer or the voltage measurer measures a temperature or a voltage, and perform a control operation so that the power supply voltage can be automatically cut off when an operation of measuring the specific gravity (concentration) of a predetermined medium is not performed.

Preferably, the controller may perform a control operation for displaying mediums to be measured on the display unit so that the user can select a type of a medium to be measured, store a conversion equation for the specific gravity (concentration) of the selected medium, perform a calculation operation using data of the conversion equation for the specific gravity (concentration) based on the selected type of the medium according to the user's intention, and perform a control operation for displaying a result of the calculation operation on the display unit.

Preferably, the controller may assign a unique number to a medium to be measured when at least one medium is continuously measured, and perform a control operation so that measurement data corresponding to the unique number can be stored.

In accordance with yet another aspect of the present invention, there is provided a method for measuring a specific gravity (concentration) of a medium using an ultrasonic wave, comprising the steps of: (a) displaying at least one medium to be measured on a display unit such that a user can select the medium to be measured; (b) measuring a propagation velocity of the ultrasonic wave for the medium selected by the user, reading a conversion equation for a specific gravity (concentration) corresponding to the selected medium, and inputting a value of the measured propagation velocity of the ultrasonic wave into the conversion equation; and (c) displaying the value of the specific gravity (concentration) calculated automatically by the conversion equation for the specific gravity (concentration).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a vehicle battery;

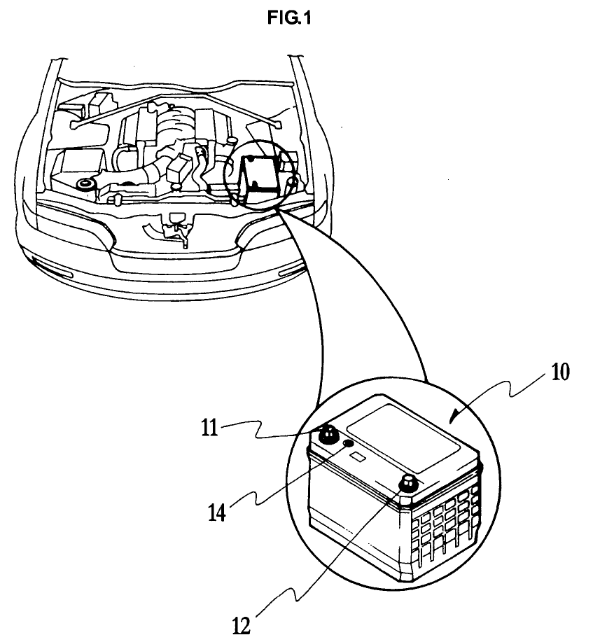

FIG. 2 is a view illustrating a structure of an industrial battery;

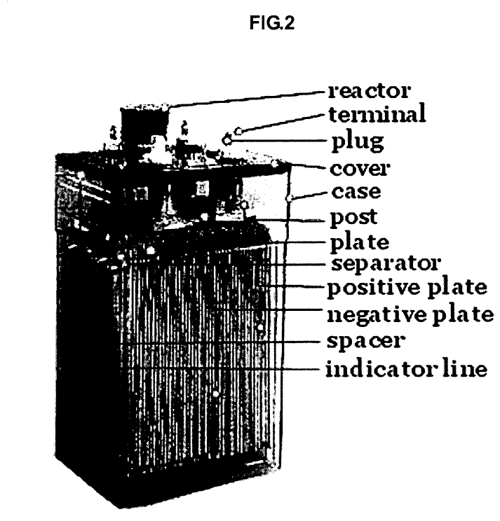

FIG. 3 is a block diagram illustrating an apparatus for measuring a specific gravity (concentration) of a medium using an ultrasonic wave in accordance with the present invention;

FIG. 4 is a circuit diagram illustrating the apparatus for measuring the specific gravity (concentration) of the medium using the ultrasonic wave in accordance with the present invention; and

FIG. 5 is a flowchart illustrating a method for measuring the specific gravity (concentration) of the medium using the ultrasonic wave in accordance with the present invention.

### DESCRIPTION OF THE PREFERRED EMBODIMENTS

Now, preferred embodiments of the present invention will be described in detail with reference to the annexed drawings.

The present invention provides an apparatus for measuring a specific gravity (concentration) of a medium using an ultrasonic wave, comprising: control means for performing a control operation for displaying at least one medium to be measured on display means such that a user can select the medium to be measured, measuring a propagation velocity of the ultrasonic wave for the medium selected by the user, reading a conversion equation for a specific gravity (concentration) corresponding to the selected medium, and inputting a value of the measured propagation velocity of the ultrasonic wave into the conversion equation; and the display means for displaying the specific gravity (concentration) calculated automatically by the conversion equation for the specific gravity (concentration). In accordance with the present invention, where the specific gravity (concentration) needs to be regulated using the conversion equation contained in the control means, as a target specific gravity value, a measured specific gravity value and a volume value is inputted, a value of an element (e.g., an amount of sodium chloride, an amount of sulfuric acid or etc.) needed to regulate the specific gravity (concentration) can be correctively calculated and a target specific gravity or concentration is easily produced.

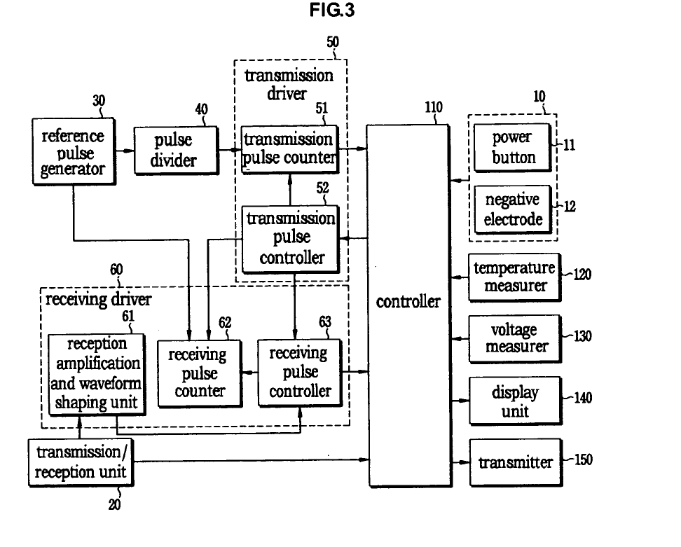

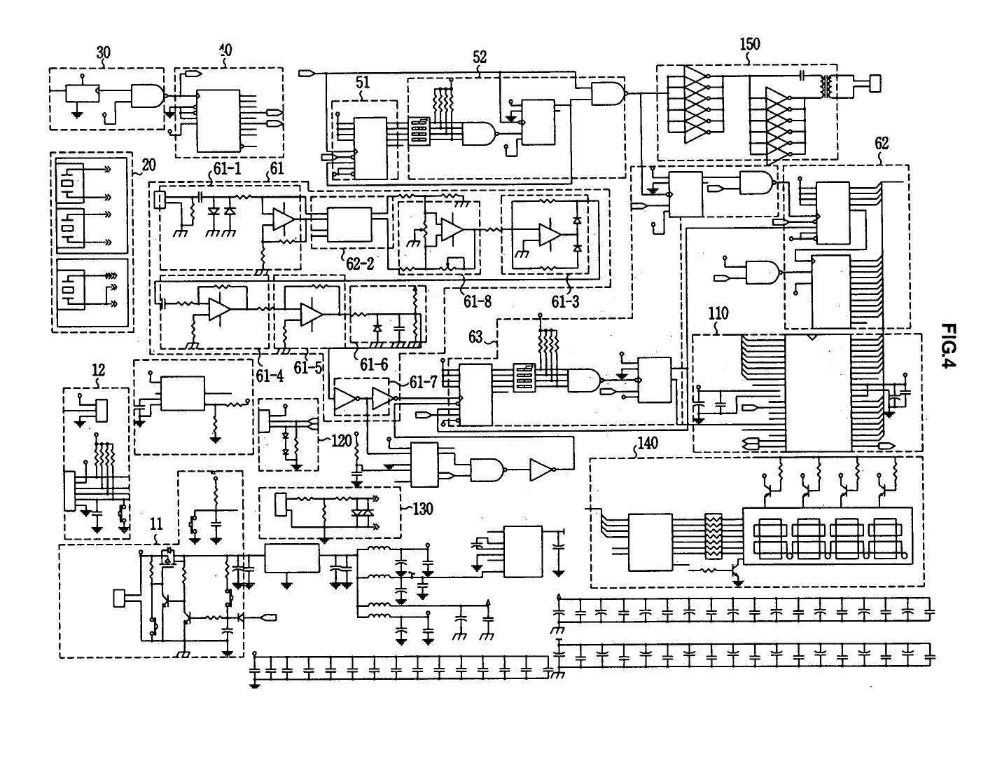

FIG. 3 is a block diagram illustrating an apparatus for measuring a specific gravity (concentration) of a medium using an ultrasonic wave in accordance with the present invention; and FIG. 4 is a circuit diagram illustrating the apparatus for measuring the specific gravity (concentration) of the medium using the ultrasonic wave in accordance with the present invention.

First, referring to FIGS. 3 and 4, configurations of the present invention are as follows.

A manipulation unit 10 includes a power button 11 for applying or cutting off a power supply voltage in response to a user's manipulation, and a voltage measurement button 12 for inputting a voltage measurement request.

A transmission/reception unit 20 receives an electric signal to convert the electric signal into the ultrasonic wave, and receives the ultrasonic wave to convert an ultrasonic wave into an electric signal.

A reference pulse generator 30 generates a reference pulse, to be used as a reference time, matching a measurement time.

A pulse divider 40 receives the reference pulse from the reference pulse generator 30 and generates a control clock and an ultrasonic wave transmission pulse.

A transmission driver 50 includes a transmission pulse counter 51 and a transmission pulse controller 70. The transmission pulse counter 51 generates the predetermined number of pulses from the ultrasonic wave transmission pulse outputted by the pulse divider 40 in response to a transmission start signal inputted by a controller 110, and outputs the generated pulses. The transmission pulse controller 70 transmits the pulses generated by the transmission pulse counter 51 to the transmission/reception unit 20, and cuts off a transmission operation for the predetermined number of pulses in response to a control signal inputted by the controller 110.

A receiving driver 60 includes a reception amplification and waveform shaping unit 61, a receiving pulse counter 62 and a receiving pulse controller 63. The reception amplification and waveform shaping unit 61 amplifies the pulses, received from the transmission/reception unit 20, by a predetermined level, and shapes a waveform of the pulses. The receiving pulse counter 62 counts reference pulses inputted by the reference pulse generator 30 in response to a counting start signal inputted by the transmission pulse controller 52 and stops a counting operation for the reference pulses in response to a counting stop signal inputted by the transmission pulse controller 70. The receiving pulse controller 63 counts the pulses received from the reception amplification and waveform shaping unit 61 in response to the counting start signal inputted by the transmission pulse controller 52, and outputs a reception completion signal if the counted number of pulses matches the predetermined number of pulses.

As shown in FIG. 4, the reception amplification and waveform shaping unit 61 includes a non-inverting amplifier 61-1, a logarithmic amplifier 61-2, a half wave rectifier circuit 61-3, a differential circuit 61-4, a comparator 61-5, an integration circuit 61-6, a Schmitt trigger circuit 61-7 and a slope regulator 61-8.

The non-inverting amplifier 61-1 removes a direct current (DC) component from an ultrasonic wave signal and amplifying the ultrasonic wave signal. The logarithmic amplifier 61-2 constantly keeps amplitude of the amplified ultrasonic wave signal. The half wave rectifier circuit 61-3 outputs only an ultrasonic wave signal of a predetermined level or more in response to an offset value. The differential circuit 61-4 forms rising and falling edges of a half wave generated by the half wave rectifier circuit 61-3. The comparator 61-5 being a zero volt detector extracts a reference point of the ultrasonic wave signal and generates the ultrasonic wave signal of a square wave from the ultrasonic wave signal of a sinusoidal wave. The integration circuit 61-6 removes a spurious short signal from the ultrasonic wave signal. The Schmitt trigger circuit 61-7 shapes the ultrasonic wave signal of the square wave, removes a noise signal from the ultrasonic wave signal of the square wave, and outputs the ultrasonic wave signal. The slope regulator 61-8 varies an amplification of the ultrasonic wave signal by regulating a slope of an output signal from the logarithmic amplifier 61-2.

A temperature measurer 120 measures a temperature of a liquid.

A display unit 140 displays measurement information in response to a control signal inputted by the controller 110.

If the power button 11 of the manipulation unit 10 is manipulated by the user so that the power supply voltage can be applied, the controller 110 outputs the transmission start signal to the transmission pulse counter 51, after performing an auto setting operation in response to the control clock inputted by the pulse divider 40. The controller 110 keeps a standby state until the reception completion signal is inputted, counts a period of time between a pulse reception time and a pulse transmission time if the reception completion signal is inputted, measures the specific gravity (concentration) of the medium, and performs a control operation for displaying the measured specific gravity (concentration) and a temperature measured by a temperature measurer 120. The controller 110 outputs a voltage measurement control signal if the voltage measurement request button 12 of the manipulation unit 10 is manipulated by the user so that a voltage measurement request signal can be inputted, and performs a control operation for displaying a measured voltage on the display unit 140.

The controller 110 performs a control operation so that the power supply voltage applied to the transmission/reception unit 20 can be cut off when the temperature measurer 120 or a voltage measurer 130 measures a temperature or a voltage, and performs a control operation so that the power supply voltage can be automatically cut off when an operation of measuring the specific gravity (concentration) of a predetermined medium is not performed.

The controller 110 performs a control operation for displaying mediums to be measured on the display unit so that the user can select a type of a medium to be measured, stores a conversion equation for the specific gravity (concentration) of the selected medium, performs a calculation operation using data of the conversion equation for the specific gravity (concentration) based on the selected type of the medium according to the user's intention, and performs a control operation for displaying a result of the calculation operation on the display unit 140.

The controller 110 assigns a unique number to a medium to be measured when, at least one medium is continuously measured, and performs a control operation so that measurement data corresponding to the unique number can be stored.

The voltage measurer 130 measures a terminal voltage of a battery in response to a voltage measurement control signal from the controller 110.

A transmitter 150 externally outputs data of the measured specific gravity (concentration), temperature and voltage according to a control operation of the controller 110.

The apparatus and method for measuring a specific gravity (concentration) of a medium using an ultrasonic wave will be described in detail with reference to FIGS. 3 to 5.

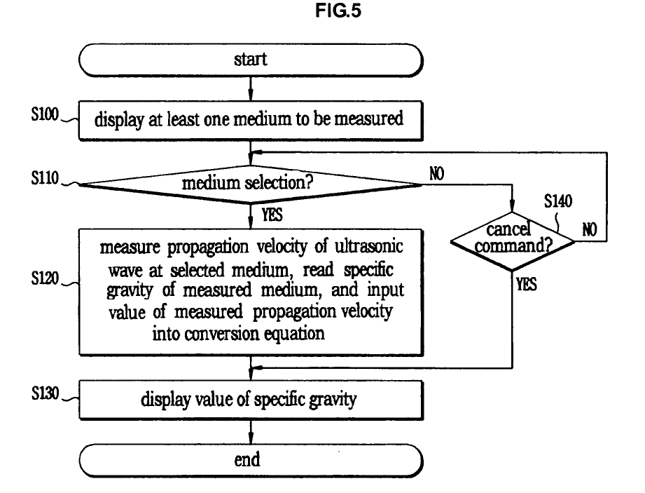

FIG. 5 is a flowchart illustrating a method for measuring the specific gravity (concentration) of the medium using the ultrasonic wave in accordance with the present invention.

First, if a power supply voltage is applied to the specific gravity (concentration) measuring apparatus of the present invention after the user presses the power button 11 of the manipulation unit 10, the display unit 140 displays at least one medium, to be measured, stored in an internal memory such that the user can select the medium after the controller 110 initializes an entire system at step S100.

The controller 110 determines whether the user has selected the medium to be measured at step S110. If the user has selected the medium to be measured as a result of the determination, the controller 110 measures a propagation velocity of an ultrasonic wave at the medium selected by the user. A conversion equation for the specific gravity (concentration) of the measured medium is read from the internal memory and a value of the measured propagation velocity is inputted into the conversion equation at step S120. The display unit 140 displays a value of the specific gravity (concentration) automatically produced at step S130. On the other hand, if the user has not selected the medium to be measured as the result of the determination at the above step S110, the controller 110 determines whether the user has made a cancel command at step S140. If the user has made the cancel command as a result of the determination, the controller 110 releases a specific gravity (concentration) measuring mode. On the other hand, the above step S110 is repeated.

At this time, the ultrasonic wave's propagation velocity is given by the following equation.

A typical propagation velocity of a medium, being V (m/s)=frequency (Hz) x wavelength (m). The propagation

$$velocity C = \sqrt{\frac{B}{ρ}} ( m \text{/} s )$$

where B is the medium's volume modulus, and ρ is the medium's density.

Thus, relations between a sound wave's velocity, temperature and density in a liquid are given by the following equations.

Velocity of sound=1447.4(m/s) (1+0.00183) where T is a Celsius temperature.

For example, when it is assumed that the specific gravity (concentration) of sulfuric acid is varied by a value of 0.0007 every time 1° C. is incremented or decremented, S25=St+0.0007(t−25) where St is an actually measured specific gravity (concentration) and t is an actually measured temperature.

The ultrasonic wave's propagation velocity varies with the medium's density. Thus, if a transmitter of the transmission/reception unit 20 transmits the ultrasonic wave, a receiver of the transmission/reception unit 20 receives the ultrasonic wave reflected from a measurement object. At this time, a distance between the object and the transmission/reception unit 20 can be calculated if the ultrasonic wave's velocity and a period of time between a transmission time and reception time are measured.

L=(T×V)/2 (m) where the distance is L (m), the measured time period is T (s) and V (m/s) is a velocity of sound.

If the power button 11 of the manipulation unit 10 is manipulated by the user so that the power supply voltage can be applied, the controller 110 outputs the transmission start signal to the transmission pulse counter 51, after performing an auto setting operation in response to the control clock inputted by the pulse divider 40. The controller 110 keeps a standby state until the reception completion signal is inputted, counts a period of time between a pulse reception time and a pulse transmission time if the reception completion signal is inputted, measures the specific gravity (concentration) of the medium, and performs a control operation for displaying the measured specific gravity (concentration) and a temperature measured by a temperature measurer 120. The controller 110 outputs a voltage measurement control signal if the voltage measurement request button 12 of the manipulation unit 10 is manipulated by the user so that a voltage measurement request signal can be inputted, and performs a control operation for displaying a measured voltage on the display unit 140.

The controller 110 performs a control operation so that the power supply voltage applied to the transmission/reception unit 20 can be cut off when the temperature measurer 120 or the voltage measurer 130 measures a temperature or a voltage, and performs a control operation so that the power supply voltage can be automatically cut off when an operation of measuring the specific gravity (concentration) of a predetermined medium is not performed.

The controller 110 performs a control operation for displaying mediums to be measured on the display unit so that the user can select a type of a medium to be measured, stores a conversion equation for the specific gravity (concentration) of the selected medium, performs a calculation operation using data of the conversion equation for the specific gravity (concentration) based on the selected type of the medium according to the user's intention, and performs a control operation for displaying a result of the calculation operation on the display unit 140.

The controller 110 assigns a unique number to a medium to be measured when at least one medium is continuously measured, and performs a control operation so that measurement data corresponding to the unique number can be stored.

In accordance with the present invention, an apparatus for measuring a specific gravity (concentration) of a medium using an ultrasonic wave are applicable to not only a vehicle battery, but also all technical fields for measuring the specific gravity (concentration). Where the specific gravity (concentration) needs to be regulated using the conversion equation contained in the controller 110, as a target specific gravity value, a measured specific gravity value and a volume value is inputted, the apparatus for measuring the specific gravity (concentration) of the medium using the ultrasonic wave can correctively calculate a value of an element (e.g., an amount of sodium chloride, an amount of sulfuric acid or etc.) needed to regulate the specific gravity (concentration), and easily produce a target specific gravity or concentration.

As apparent from the above description, the present invention provides an apparatus, and method for measuring a specific gravity (concentration) of a medium using an ultrasonic wave, which can measure a propagation velocity of the ultrasonic wave to recognize a change of density and temperature of the medium using the measured propagation velocity of the ultrasonic wave, and for measuring the specific gravity (concentration) of the medium using the recognized change of the density and temperature of the medium using a device for converting an electric signal into an ultrasonic wave, a device for converting the ultrasonic wave into the electric signal and a device for generating and detecting the ultrasonic wave.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for measuring a specific gravity (concentration) of a medium using an ultrasonic wave, comprising:
control means for performing a control operation for displaying at least one medium to be measured on display means such that a user can select the medium to be measured, measuring a propagation velocity of the ultrasonic wave for the medium selected by the user, reading a conversion equation for a specific gravity (concentration) corresponding to the selected medium, and inputting a value of the measured propagation velocity of the ultrasonic wave into the conversion equation; and
the display means for displaying the specific gravity (concentration) calculated automatically by the conversion equation for the specific gravity (concentration).

2. An apparatus for measuring a specific gravity (concentration) of a medium using an ultrasonic wave, comprising:
a manipulation unit including:
a power button for applying or cutting off a power supply voltage in response to a user's manipulation; and
a voltage measurement button for inputting a voltage measurement request;
a transmission/reception unit for receiving an electric signal to convert the electric signal into the ultrasonic wave, and receiving the ultrasonic wave to convert an ultrasonic wave into an electric signal;
a reference pulse generator for generating a reference pulse, to be used as a reference time, matching a measurement time;
a pulse divider for receiving the reference pulse from the reference pulse generator and generating a control clock and an ultrasonic wave transmission pulse;
a transmission driver including:
a transmission pulse counter for generating the predetermined number of pulses from the ultrasonic wave transmission pulse outputted by the pulse divider in response to a transmission start signal of an external input, and outputting the generated pulses; and
a transmission pulse controller for transmitting the pulses generated by the transmission pulse counter to the transmission/reception unit, and cutting off a transmission operation for the predetermined number of pulses in response to a control signal inputted by a controller; a receiving driver including:
a reception amplification and waveform shaping unit for amplifying the pulses, received from the transmission/reception unit, by a predetermined level, and shaping a waveform of the pulses;
a receiving pulse counter for counting reference pulses inputted by the reference pulse generator in response to a counting start signal inputted by the transmission pulse controller and stopping a counting operation for the reference pulses in response to a counting stop signal as an external input; and
a receiving pulse controller for counting the pulses received from the reception amplification and waveform shaping unit in response to the counting start signal inputted by the transmission pulse controller, comparing a comparative value corresponding to a count signal from the reception pulse counter outputting a reception completion signal with a reference value corresponding to the predetermined number of pulses, if the counted number of pulses matches the predetermined number of pulses, and outputting the counting stop signal to the receiving pulse counter if the comparative value matches the reference value;
a temperature measurer for measuring a temperature of a liquid;
a display unit for displaying measurement information in response to a control signal as an external input;
the controller for outputting the transmission start signal to the transmission pulse counter, after performing an auto setting operation in response to the control clock inputted by the pulse divider, if the power button of the manipulation unit is manipulated by the user so that the power supply voltage can be applied, keeping a standby state until the reception completion signal is inputted, counting a period of time between a pulse reception time and a pulse transmission time if the reception completion signal is inputted, measuring the specific gravity (concentration) of the medium, performing a control operation for displaying the measured specific gravity (concentration) and a temperature measured by a temperature measurer, outputting a voltage measurement control signal if the voltage measurement request button of the manipulation unit is manipulated by the user so that a voltage measurement request signal can be inputted, and performing a control operation for displaying a measured voltage on the display unit;
a voltage measurer for measuring a terminal voltage of a battery in response to a voltage measurement control signal from the controller; and
a transmitter for externally outputting data of the measured specific gravity (concentration), temperature and voltage according to a control operation of the controller.

3. The apparatus as set forth in claim 2, wherein the reception amplification and waveform shaping unit comprises:
a non-inverting amplifier for removing a direct current (DC) component from an ultrasonic wave signal and amplifying the ultrasonic wave signal;
a logarithmic amplifier for constantly keeping an amplitude of the amplified ultrasonic wave signal;
a half wave rectifier circuit for outputting only an ultrasonic wave signal of a predetermined level or more in response to an offset value;
a differential circuit for forming rising and falling edges of a half wave generated by the half wave rectifier circuit;
a comparator being a zero volt detector for extracting a reference point of the ultrasonic wave signal and generating the ultrasonic wave signal of a square wave from the ultrasonic wave signal of a sinusoidal wave;
an integration circuit for removing a spurious short signal from the ultrasonic wave signal;
a Schmitt trigger circuit for shaping the ultrasonic wave signal of the square wave, removing a noise signal from the ultrasonic wave signal of the square wave, and outputting the ultrasonic wave signal; and
a slope regulator for varying an amplification of the ultrasonic wave signal by regulating a slope of an output signal from the logarithmic amplifier.

4. The apparatus as set forth in claim 2, wherein the controller performs a control operation so that the power supply voltage applied to the transmission/reception unit can be cut off when the temperature measurer or the voltage measurer measures a temperature or a voltage, and performs a control operation so that the power supply voltage can be automatically cut off when an operation of measuring the specific gravity (concentration) of a predetermined medium is not performed.

5. The apparatus as set forth in claim 2, wherein the controller performs a control operation for displaying mediums to be measured on the display unit so that the user can select a type of a medium to be measured, stores a conversion equation for the specific gravity (concentration) of the selected medium, performs a calculation operation using data of the conversion equation for the specific gravity (concentration) based on the selected type of the medium according to the user's intention, and performs a control operation for displaying a result of the calculation operation on the display unit.

6. The apparatus as set forth in claim 1, wherein the controller assigns a unique number to a medium to be measured when at least one medium is continuously measured, and performs a control operation so that measurement data corresponding to the unique number can be stored.

7. A method for measuring a specific gravity (concentration) of a medium using an ultrasonic wave, comprising the steps of:
(a) displaying at least one medium to be measured on a display unit such that a user can select the medium to be measured;
(b) measuring a propagation velocity of the ultrasonic wave for the medium selected by the user, reading a conversion equation for a specific gravity (concentration) corresponding to the selected medium, and inputting a value of the measured propagation velocity of the ultrasonic wave into the conversion equation; and
(c) displaying the value of the specific gravity (concentration) calculated automatically by the conversion equation for the specific gravity (concentration).
